(19) United States
(12) Patent Application Publication
(10) Pub. No.: US 2014/0188636 A1
(43) Pub. Date: Jul. 3, 2014

(54) REACTIVE AD FORMATS

(71) Applicant: GOOGLE INC., Mountain View, CA (US)

(72) Inventors: Danielle Hope VANDYKE, Mountain View (CA); Timothy ZWIEBEL, Mountain View, CA (US)

(73) Assignee: GOOGLE INC., Mountain View, CA (US)

(21) Appl. No.: 13/733,709

(22) Filed: Jan. 3, 2013

(51) Int. Cl. G06Q 30/02

(52) U.S. Cl. CPC G06Q 30/0277
USPC 705/14.73

(57) ABSTRACT

Systems and methods of creating and presenting reactive advertisements within an application are provided. Reactive advertisements include ones configured to or capable of changing position, color, size, and other properties based on instruction from or in response to changes within an application. Some reactive advertisements may include an externally accessible logic portion that accepts inputs and adjusts behavior and presentation of a content portion, which is the ad portion that is displayed in the application.

### FIELD

The present disclosure pertains to online and in-app advertisement formats capable of self-adjusting in response to changes in the ad presentation environment without requiring a call to an ad server for new graphics, new content, new presentation parameters and/or a new advertisement. More specifically, the disclosure pertains to reactive advertisement modules that contain the necessary logic for reacting to one or more local device display environment changes by communicating directly with one or more of the local device applications or utilities that cause the display environment changes.

### BACKGROUND

An advertisement shown inside a mobile application or a web browser (or an application running in a web browser) is generally static in regards to the rest of the app/web experience. The ad unit is fixed in position, such as at the top of the app or in a specific location on a scrollable page or in relation to a screen location, and behaves according to its own rules. In some cases, these rules include remaining anchored at the top of the screen or some other fixed location, or being presented at a particular display resolution. If the advertiser wants to change the ad unit location or look, they must request a new ad from the advertising network's servers. The ad does not directly interact with the app or web environment and does not register or respond to changes within that environment.

### SUMMARY

The techniques, devices, and systems disclosed herein pertain, in part, to a method of adjusting the display settings of a served advertisement presented concurrently with an application on a data access device display, from within the application, the method comprising: identifying, within the application, a change in a display status of the application; sending the identified change from the application to the served advertisement; altering at least one of advertisement position within the application, advertisement orientation with respect to the device display, advertisement color scheme relative to the application, and advertisement animation relative to the display; and presenting the altered advertisement on the display concurrently with the application; where the identifying, sending, altering, and presenting steps are performed locally on the device.

In some variations, the step of altering includes: receiving, in the advertisement, the identified change information from the application; determining, from the received change information, at least one display change type; setting at least one advertisement display or behavior parameter based on said determined display change type; and informing the application of said setting.

In some variations, the step of sending includes: determining, within the application, a display change type; calculating, within the application, new display instructions for the advertisement; and sending the new display instructions to the advertisement.

In some variations, the step of setting includes changing a color scheme of the advertisement.

In some variations, the application is a game.

In some variations, the data access device is a mobile phone.

In some variations, the method further includes steps of: storing display parameters based on the altered advertisement within the application; replacing the altered advertisement with a new served advertisement from an advertisement server; and applying said stored display parameters to the new served advertisement during display of said new served advertisement concurrently with the application.

In some variations, the method further includes steps of: receiving the sent identified change information from the application with a logic portion of said advertisement; creating, with said logic portion, mark-up data defining how a content portion of said advertisement is rendered based on the received change information; and where said altering includes re-rendering the content portion based on the created mark-up data.

In some variations, the step of creating mark-up data includes creating mark-up data based on a local mark-up template stored on the device.

In some variations, the step of creating mark-up data includes creating mark-up data based on mark-up information stored in an ads database. In some variations, the mark-up data may include mark-up language. In some variations, such mark-up language may be generated by server serving the served advertisement.

In some variations, the identified change includes specific instructions for altering an appearance of the advertisement within the application, and where said altering is accomplished by applying said specific instructions to the advertisement.

The techniques, devices, and systems disclosed herein may pertain, at least in part, to a system comprising: a processor; a computer-readable memory having stored therein a set of instructions which, when carried out by the processor, cause the processor to perform some or all of the method steps and variations thereof as discussed above. The techniques, devices, and systems disclosed herein may pertain, at least in part, to a non-transitory computer-readable medium having embodied thereon instructions, which, when executed by one or more processors, cause the processor(s) to perform some or all of the method steps and variations thereof as discussed above.

Further scope of applicability of the systems and methods discussed will become apparent from the detailed description given hereinafter. However, it should be understood that the detailed description and specific examples, while indicating preferred embodiments of the systems and methods, are given by way of illustration only, since various changes and modifications within the spirit and scope of the concepts disclosed herein will become apparent to those skilled in the art from this detailed description.

### BRIEF DESCRIPTION OF THE DRAWINGS

The systems and methods discussed will become more fully understood from the detailed description given herein below and the accompanying drawings which are given by way of illustration only, and thus are not limitative, and wherein:

FIG. 1a depicts a block diagram of an embodiment of a device operating one or more ad-bearing applications and/or utilities discussed herein;

FIG. 1b depicts an embodiment of an application with a reactive ad displayed thereon as discussed herein;

FIG. 1c depicts an embodiment of an application with a reactive ad displayed thereon as discussed herein;

FIG. 1d depicts an embodiment of an application with a reactive ad displayed thereon as discussed herein;

FIG. 2a depicts a block diagram of an embodiment of a display event detection and local ad adjustment process as discussed herein;

FIG. 2b depicts a block diagram of an embodiment of a display event detection and local ad adjustment process as discussed herein;

FIG. 2c depicts a block diagram of an embodiment of a display event detection and local ad adjustment process as discussed herein; and

FIG. 3 depicts a block diagram of an embodiment of a reactive ad local adjustment process as discussed herein.

The drawings will be described in detail in the course of the detailed description.

### DETAILED DESCRIPTION

The following detailed description refers to the accompanying drawings. The same reference numbers in different drawings identify the same or similar elements. Also, the following detailed description does not limit the concepts discussed. Instead, the scope of the concepts discussed herein is defined by the appended claims and equivalents thereof.

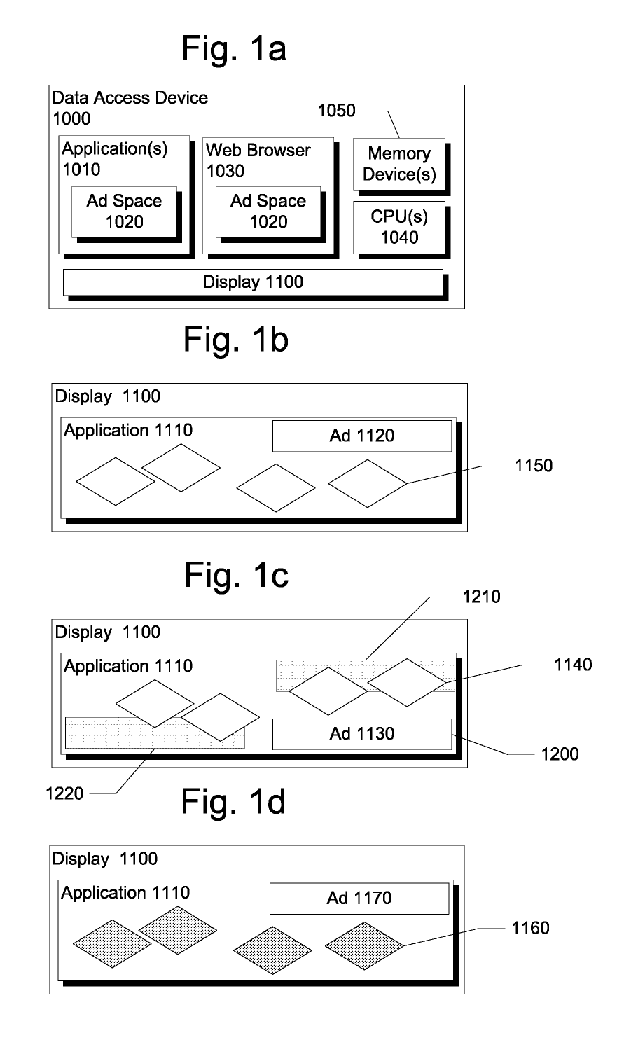

FIG. 1 depicts a block diagram of an embodiment of a data access device 1000. Such a data access device may be equipped with one or more memory devices(s) 1050 and one or more processor(s) 1040 for executing one or more application(s) 1010 and/or web browsing tools 1030 that may be presented via a display 1100 such as a screen. The application(s) 1010 and/or web tools 1030 may be equipped with or configured to have advertising space 1020 for the presentation of advertisements therein/thereon. Variations of such a data access device may include a desktop, laptop, netbook, tablet, or hand-held computing platform. Some variations of such a data access device 1000 may be equipped with a display such as a screen for presentation of application and/or web data and advertisements. A variation of a data access device display 1100 presenting an ad-bearing application is shown in FIGS. 1b-1d.

In FIG. 1b, a device display 1100 is presenting an application 1110 having certain content therein 1150 and an advertisement 1120 presented therewith. In most current ad-bearing applications, an advertisement 1120 presented in conjunction with—but that is not directly written into or part of—the application 1110 is only presented relative to the display 1100. Conventional advertisements have no awareness of events within the application 1110 or of when/how to react/respond to changes in content layout, color, or movement status of content in the application 1110. A reactive advertisement module according to the present disclosure, however, monitors and had an awareness of the content it is concurrently being presented with.

FIG. 1c shows an embodiment of an ad-enabled application 1110 presented on a device display 1100 where the content 1140 has changed or been re-located or re-arranged on the screen. A reactive advertisement 1130 in such a variation would, upon detecting a change in content 1140 layout or distribution or composition in the application 1110, re-position itself in the application 1110 without requiring input or instruction from an ads server to do so. Such re-positioning may be realized by having the application set multiple allowed advertisement positions 1200, 1210, 1220. The ad 1130 then selects one of the allowed positions 1200 and renders itself there.

The ad may then receive a signal or interpret some other cue from the application indicating that the ad needs to be re-located. Such a signal could come directly from the application or could be some monitoring logic either in the ad or otherwise provided to the ad indicating, for example, changes in display activity (i.e. a lot of pixels being re-drawn) near the ad. Such a signal may suggest that the ad is blocking content the user may want to see, causing the ad to re-render itself in one of the other allowed positions 1210, 1220. The new allowed position could also be provided by the application or determined by monitoring logic either in the ad or otherwise provided to the ad indicating, for example, a lack of change in display activity or an otherwise comparatively low or reduced amount of display activity around a permitted ad location.

Examples of such a variation include games that involve moving a character or perspective point around a virtual environment. A reactive ad in such an application may move itself to another location on the display so that it doesn't interfere with game play. For example, the ad may start as a banner across the top of the application 1110 presented in the device's display 1100, but as the game character or perspective point reaches the top of the screen, the application informs the advertisement that it is in the way and tells the ad unit to move to the bottom of the display or a different screen location. The banner, in response to the display change information from the application, re-renders itself across the bottom of the display and returns the space at the top of the display to the application.

FIG. 1d shows another embodiment of an ad-enabled application 1110 presented on a device display 1100 where the content 1160 has changed its color scheme. A reactive advertisement module 1170 in such a variation would, upon detecting a change in color scheme, adjust its own color scheme accordingly without requiring input or instruction from an ads server to do so. Additionally, because the advertisement module is equipped with its own logic, such color adjustment may be accomplished, in some variations, with little or no interaction from any outside system(s). Some variations may require input data providing a current color scheme/status of the app 1110. Other variations may poll the display 1100 or graphics-rendering portions of the device 1000 for such color information.

Examples of such a variation include an application for monitoring finances. Such an application may allow users to set the color-scheme of reports. When the user makes a change, the application may inform the advertisement the color scheme or of a new color value that compliments the selected color scheme. The ad adjusts its color scheme in response to the color scheme information. In further variations, the color scheme information may persist in a background ad selection or management information cache that informs all subsequently displayed ads in the application of the appropriate/preferred colors or preferred color schemes.

In some variations, an app or ad publisher may be able to opt in or opt out of dynamic ad property and/or location adjustment. In some variations, publishers or developers may specifically create content meant for dynamic re-configuration based on application context or behavior. In other variations, publishers of apps or ads may agree to allow third party or device-based adjustment to ad position, size, color or other properties based on application behavior.

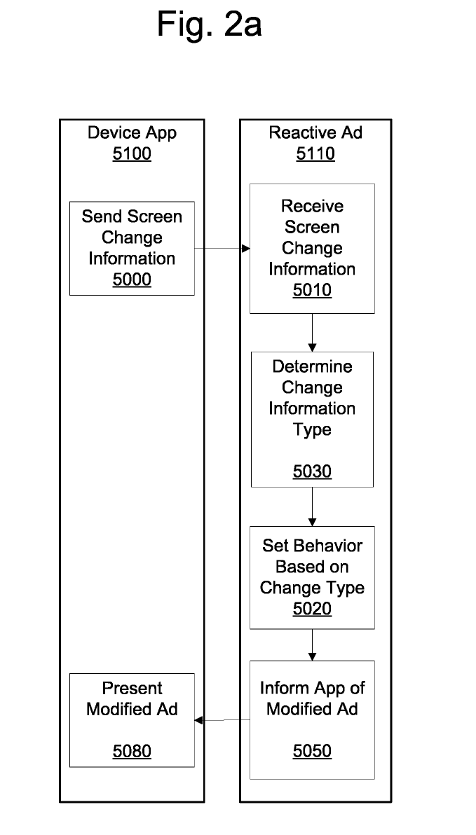

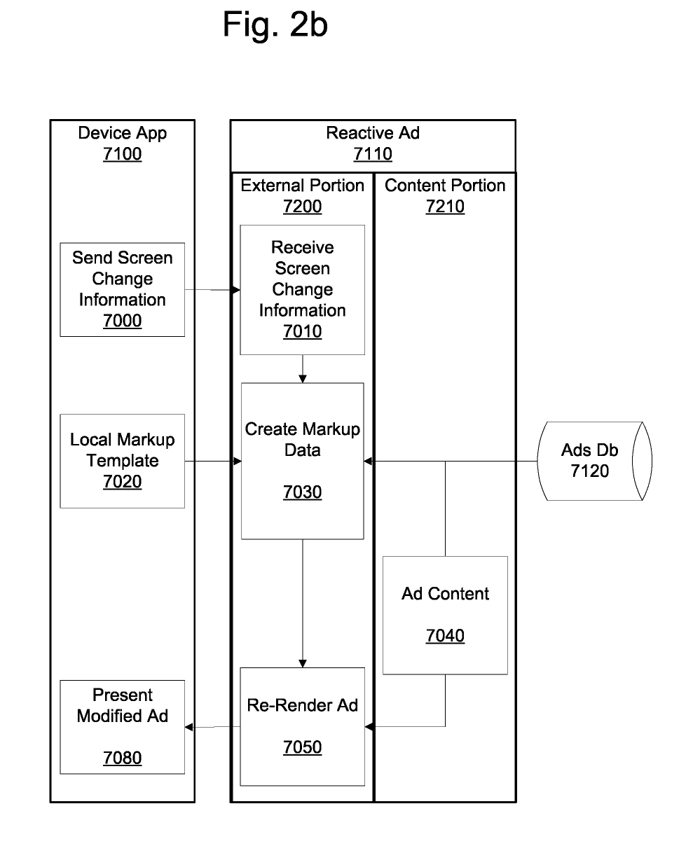

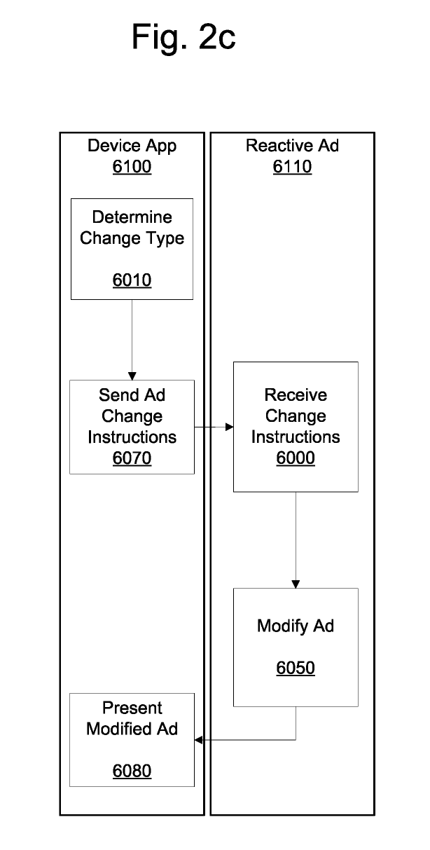

In yet further variations, an application or game may have features that cause the in-application display to shake or otherwise move or change either or both of its position or orientation (rotation/tilt) relative to either the application or to the display. A reactive advertisement displayed concurrently with such an application may also be instructed to move or shake or tilt or rotate or otherwise behave in a manner consistent with the in-application display. For example, a first person shooter game application involves intense, realistic graphics. Whenever an explosive occurs in the game, the application the shakes the players ‘view’ for a short period of time. To make the advertisement appear more natural in the game, the application may tell the ad(s) displayed thereon that they should, for example, shake horizontally for 0.5 seconds, to match the display. Other variations may also include temporary color changes, such as changing to a reddish color for a short period when the rest of the in-game display is red-hued due to a player taking damage or an item exploding or some similar effect occurring. In some variations, such adjustments to an ad may be triggered directly by the application. In such variations, the application may re-draw or re-position the ad or provide direct commands or signals to the ad for color or position changes. In some variations of a reactive advertisement, the ad unit accepts programmatic calls from the application giving it additional instructions on action, appearance, location, etc. which can be changed without a call to the advertising network's servers. The functionality can be added directly to the coding of an advertisement, giving it independent functionality that can be directly accessed by an application or program that is enabled/configured to present the ad. An embodiment of a reactive advertisement interacting with a device application is shown in FIG. 2a.

In the embodiment shown, a device application 5100 may send screen change information 5000 to a reactive ad 5110. Screen change information may include the position of a character, object, or perspective point in a game, a change in color scheme for a report or website, information related to “shaking” or coloration of a first-person perspective in a game, a change in position of an “active” portion of an application such as a highlighted or selected data input field.

The reactive ad module 5110, which includes an advertisement displayed during the use or access of the device app 5100 but that is not itself part of or otherwise programmed/coded into the app 5100, receives the screen change information 5010. In some variations, the reactive ad 5110 may determine the screen change information type 5030 from the received screen change information 5010. Change information type may include color, position, motion, and combinations thereof. In some variations, the screen change information sent from the app 5000 may include a specific instruction related to one or more of motion, position, and color. In some variations, screen change information may also include information such as tilt, orientation, audio state, power status, detected motion, detected position, other forms of sensor data available on the device, and/or network connectivity state of a device on which the application 5000 is running or otherwise being presented. In some such variations, the ad 5110 may omit the change information type determination step 5030 and simply alter its appearance or behavior 5020 based on the specific change information sent by the app. Variations where specific change information is sent by the device or by/from sensor data available on the device may include variations where such device or sensor data is provided to the application 5000. The application may then have its behavior or appearance altered and also provide change information or other screen or display change signals to the reactive ad 5110.

In variations where the change information 5000 is not in the form of explicit/specific instruction to the ad, but instead is in the form of information about the types of changes ongoing in the app environment, the reactive ad sets its appearance or behavior 5020 based on change information type 5030 determined by the ad. This change information type may include data in or about an ad template or mark-up language to change how the ad is rendered within the device app 5100. After the new ad behavior is set, the app is informed that the ad is modified 5050 and presents the modified ad 5080.

In some variations, communication with the ad may be accomplished by having an “external” portion of the ad that is accessible by the application or by other processes or utilities (such as, for example, via JavaScript for web applications/tools). In such a variation, the logic operating in the non-content/non-advertisement portion of the display may make a call to this “external” portion identifying a requested or suggested change. The “external” ad piece may then re-generate mark-up (such as XML or HTML) of the rendered ad using the ad content from an ad server and, in some cases, a client-side mark-up template, and also in some cases a value passed from the non-advertisement portion, such as a new position or background color. The external portion then re-renders the ad using this newly generated mark-up.

An embodiment showing interaction between an application on a device and an external portion of a reactive advertisement presented thereon is shown in FIG. 2b.

In the embodiment shown, a device application 7100 may send screen change information 7000 to an external or externally accessible portion 7200 of a reactive ad 7110. Screen change information may include the position of a character, object, or perspective point in a game, a change in color scheme for a report or website, information related to “shaking”, coloration, or visual elements of a first-person perspective in a game, a change in position of an “active” portion of an application such as a highlighted or selected data input field, available space for ad (dimensions of the space available, position on the display 1100 of the space available), player achievements within the application.

The external reactive ad portion 7200, which is a portion of the reactive ad 7110 distinct from, but connected with the ad content portion 7210 displayed during the use or access of the device app 7100, and which is not itself part of or otherwise programmed/coded into the app 7100, receives the screen change information 7010. This screen change information may, in some variations, include simply a signal indicating that screen data has changed and the external portion 7200 should query or otherwise poll display or rendering processes to determine a change type. In other variations, the screen change information 7010 may include more specific data about display changes in the application.

In either variation, the screen change information may include changes in color, position, motion, and combinations thereof. In some variations, the screen change information sent from the app 7000 may include a specific instruction related to one or more of motion, position, and color. In such variations, the external portion 7200 may create new mark-up data for presentation of the ad 7030 based on the received screen change information 7010 and either a local mark-up template 7020 stored on the device 7100 or mark-up data stored in the ad content 7040 or in an ads database 7120.

In variations where the received screen change information 7010 is not in the form of explicit/specific change information, but instead is in the form of information about the types of changes occurring in the app environment, the external portion 7200 may omit or may not even have access to a local mark-up template 7020 and may have to create new mark-up data for ad presentation based purely on ad content 7040 or, in some cases only on mark-up data available from an ads database 7120. After the new mark-up data is created 7030, the external portion re-renders the ad content 7050 and informs the device or device app 7100 to present the modified ad content 7080.

In another variation, an app or application may control a reactive ad directly through function calls to the “external” portion of the reactive ad. Such a variation is depicted in FIG. 2c. In the variation shown, an app 6100 running on a device may more quickly and more correctly determine a display environment change type 6010 occurring within itself. The app may also be aware of the location, color, and current behavior of the ad based on either initial ad display parameters or the last-sent change instructions from the app to the ad. Such information may enable the app to determine a proper instruction set based on the determined change type 6010 occurring in the app. The app 6100 may then send ad change instructions 6070 based on the determined change type 6010.

The reactive ad 6110 receives the change instructions 6000 from the app. The change instructions 6000 may include information about new position, color, and/or motion parameters. In some variations, the change instructions may include absolute instructions, such as a specific color scheme, in-app location, and/or motion type. In further variations, the change instructions may include relative information such as an amount of vertical or horizontal movement, a degree of change in color scheme, an amount or time-period of dynamic motion, or some combination thereof.

The ad 6110 is modified 6050 based on the received change instructions 6000 and the device app 6100 presents the modified ad 6080 until the display/presentation time for the ad expires, the app is closed, or another display change event warranting a change to ad behavior occurs in the app.

Information exchange between the app 7100 and the external portion of the reactive ad 7200 may occur over any number of data exchange/communication channels internal to a data access/data processing device. The app 7100 and ad 7110 may be separate programs/objects stored in one or more memory locations and operated on by one or more processors in the device. Information pertaining to screen change information and ad behavior modification may be exchanged between the two programs/objects via registers and/or buses used to store information within a processor or pass information between a processor and a memory.

Further variations of ad change instructions 6070 may include behaviors and parameters outside of ad color, location, and animation. Some variations may enable/disable multimedia aspects of an ad, such as sound, video, or video-like cycling of still frames. For example, an ad with multimedia/video components or eye-catching animations/movement may be disabled during portions of an app where user attention/focus is required—such as when modifying user profile information in a financial/banking app or during particular action sequences in a game. Further variations may also allow an app to provide its current multimedia settings to a reactive ad. In such variations, an app operating in muted mode may instruct ads presented thereon to also operate in muted mode regardless of whether the overall device is operating in muted mode.

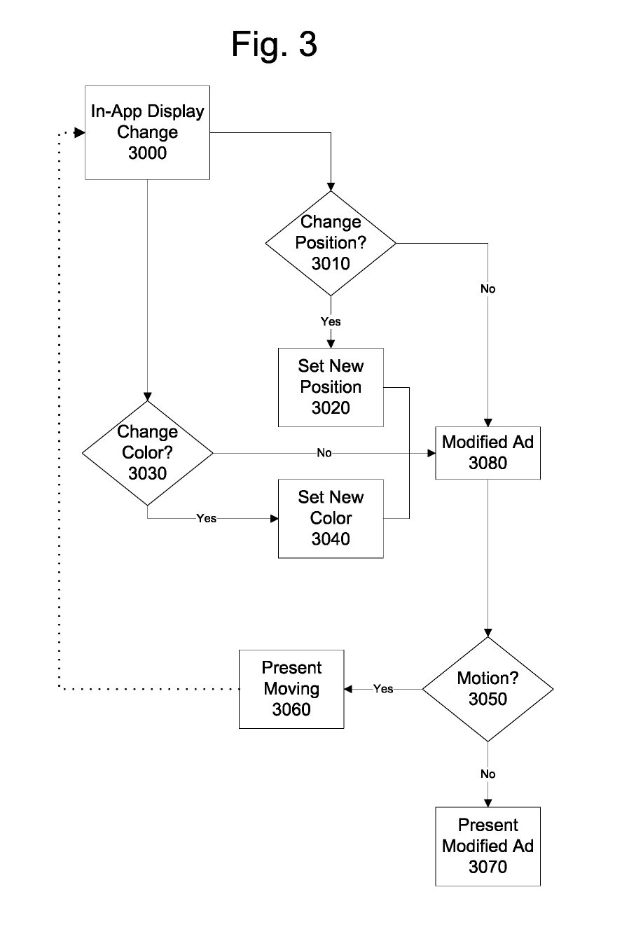

An example of a workflow associated with an in-app ad modification triggered by a display change is depicted in FIG. 3. In the variation shown, recognition of a display change event 3000 causes either the application or the ad (depending on configuration) to determine whether changes are required to color 3030 and/or position 3010 of the ad within the app. In the variation shown, these determinations are made in parallel. In other variations, these determinations may be made serially or as part of an overall combined process that evaluates both parameters/parameter sets at the same time.

If a new position is required, a new position may be set 3020 by either the application, in the form of instructions, or by the ad, based on display information received from the application. A new color may be set 3040 in a similar fashion. After color and position information/changes are determined and set, a modified ad 3080 is analyzed to determine if some motion 3050 or other type of animation (such as color fading in and out) may be required/instructed. If no motion or animation 3050 is required, the modified ad 3080 is presented 3070 and displayed. If motion is required, the modified ad 3080 is presented in the moving/animated format 3060. In some variations, a moving/animated format presentation 3060 may inherently or automatically trigger a subsequent display change detection 3000 to determine when to stop/change the motion animation. In other variations, a setting of motion/animation may include a time limit or a series or repetitions or some other terminable or self-terminating process informed or instructed by the host app/application.

In some cases, little distinction remains between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Only exemplary embodiments of the systems and solutions discussed herein are shown and described in the present disclosure. It is to be understood that the systems and solutions discussed herein are capable of use in various other combinations and environments and are capable of changes or modifications within the scope of the concepts as expressed herein. Some variations may be embodied in combinations of hardware, firmware, and/or software. Some variations may be embodied at least in part on non-transitory computer-readable storage media such as memory chips, hard drives, flash memory, optical storage media, or as fully or partially compiled programs suitable for transmission to/download by/installation on various hardware devices and/or combinations/collections of hardware devices. Such variations are not to be regarded as departure from the spirit and scope of the systems and solutions discussed herein, and all such modifications as would be obvious to one skilled in the art are intended to be included within the scope of the following claims:

1. A method of adjusting the display settings of a served advertisement presented concurrently with an application on a data access device display, from within the application, the method comprising:
identifying, within the application, a change in a display status of the application;
sending information about the identified change from the application to the served advertisement;
altering at least one of advertisement position within the application, advertisement orientation with respect to the device display, advertisement color scheme relative to the application, and advertisement animation relative to the display based on the identified change; and
presenting the altered advertisement on the display concurrently with the application; where
said identifying, sending, altering, and presenting steps are performed locally on the device.

2. The method of claim 1, where said altering includes:
receiving, in the advertisement, the identified change information from the application;
setting at least one advertisement display or advertisement behavior parameter based on said identified change information; and
informing the application of said set display or behavior parameter.

3. The method of claim 1, where said sending includes:
determining, within the application, a display change type that indicates a change in at least one of said advertisement position, said advertisement orientation, said advertisement color scheme, and said advertisement animation;
calculating, within the application, new display instructions for the advertisement based on the determined display change type; and
sending the new display instructions to the advertisement, and
where said altering includes performing said altering based on the new display instructions.

4. The method of claim 2, where said setting includes changing a color scheme of the advertisement.

5. The method of claim 1, where the application is a game.

6. The method of claim 1, the method further comprising:
storing display parameters based on the altered advertisement within the application;
replacing the altered advertisement with a new served advertisement from an advertisement server; and
applying said stored display parameters to the new served advertisement during display of said new served advertisement concurrently with the application.

7. The method of claim 1, the method further comprising:
receiving the sent identified change information from the application with a logic portion of said advertisement;
creating, with said logic portion, mark-up data defining how a content portion of said advertisement is rendered based on the received change information; and
where said altering includes re-rendering the content portion based on the created mark-up data.

8. The method of claim 7, where said creating mark-up data includes creating mark-up data based on a local mark-up template stored on the device.

9. The method of claim 7, where said creating mark-up data includes creating mark-up data based on mark-up information stored in an ads database.

10. The method of claim 1, where the identified change includes specific instructions for altering an appearance of the advertisement within the application, and where said altering is accomplished by applying said specific instructions to the advertisement.

11. The method of claim 1, the method further comprising serving the advertisement to the data access device over a data transmission network based on an advertisement request generated by the application.

12. The method of claim 2, the method further comprising:
receiving the sent identified change information from the application with a logic portion of said advertisement;
where said setting includes creating, with said logic portion, mark-up data defining how a content portion of said advertisement is rendered based on the received change information;
where said informing includes providing the created mark-up data to the application; and
where said altering includes re-rendering the content portion based on the created mark-up data.

13. A system comprising:
a processor disposed in a data access device;
a computer-readable memory having stored therein a set of instructions which, when carried out by the processor, cause the processor to perform a method of adjusting the display settings of a served advertisement presented concurrently with an application on a display of the data access device, from within the application, the method comprising:
identifying, within the application, a change in a display status of the application;
altering at least one of advertisement position within the application, advertisement orientation with respect to the device display, advertisement color scheme relative to the application, and advertisement animation relative to the display based on the identified change; and
presenting the altered advertisement on the display concurrently with the application; where
said identifying, altering, and presenting steps are performed locally on the device.

14. The system of claim 13, where the data access device is a mobile telephone.

15. The system of claim 13, the system further comprising a data communication unit disposed in the data access device, where the data communication unit receives the served advertisement; said served advertisement being served to the data access device over a data transmission network in response to an advertisement request generated by the application.

16. The system of claim 13, the system further comprising:
a parameter memory that stores advertisement display parameters based on a result of said altering; and
wherein the processor further carries out a step of applying said stored display parameters to a new served advertisement displayed concurrently with the application in response to receiving, with the data access device, a new served advertisement that replaces the altered advertisement.

17. The system of claim 13, wherein the step of altering includes:
creating mark-up data defining how a content portion of said advertisement is rendered based on the received change information; and
re-rendering the content portion based on the created mark-up data.

18. The system of claim 13, where the processor performs said altering based on instructions from a logic portion of the served advertisement.

19. A method of adjusting the display settings of a served advertisement presented concurrently with an application on a data access device display, from within the application, the method comprising:
identifying, within the application, a change in a display status of the application;
sending the identified change from the application to the served advertisement;
receiving the sent identified change information from the application with a logic portion of the served advertisement;
creating, with said logic portion, mark-up data defining how a content portion of said served advertisement is rendered on the device display based on the received change information;
re-rendering the content portion of the advertisement on the device display based on the created mark-up data, where said re-rendering includes altering at least one of advertisement position within the application, advertisement orientation with respect to the device display, advertisement color scheme relative to the application, and advertisement animation relative to the display; and
presenting the altered advertisement on the display concurrently with the application; where said identifying, sending, re-rendering, and presenting steps are performed locally on the device.

20. The method of claim 19, where said creating mark-up data includes creating mark-up data based on mark-up information stored in an ads database.
